(19) United States
(12) Patent Application Publication
(10) Pub. No.: US 2015/0306618 A1
(43) Pub. Date: Oct. 29, 2015

(54) Adjustable Fluid Sprayer

(71) Applicant: Petter Investments, South Haven, MI (US)

(72) Inventors: Matthew J. Petter, South Haven, MI (US); Douglas A. Petter, South Haven, MI (US); Lucas G. Schrab, Plainwell, MI (US)

(73) Assignee: Petter Investments, South Haven, MI (US)

(21) Appl. No.: 14/260,961

(22) Filed: Apr. 24, 2014

(51) Int. Cl. B05B 12/12; B05B 1/30

(52) U.S. Cl. CPC B05B 12/12; B05B 1/30

(57) ABSTRACT

A sprayer includes a nozzle, a nozzle actuator connected to the nozzle, and a controller in communication with the nozzle actuator. The controller receives wind data (e.g. from a wind sensor), determines a nozzle adjustment based on the wind data, and controls the nozzle actuator to alter a spray state of the nozzle based on the nozzle adjustment.

### TECHNICAL FIELD

This disclosure relates generally to fluid sprayers having adjustable nozzles.

### BACKGROUND

Generally, sprayers include a nozzle that may control a spray direction and flow characteristics of a fluid (e.g., liquid or gas) exiting a pipe or hose. Sprayers may be used in irrigation, landscape watering, fire-fighting, washing or rinsing objects, and paint spraying, among other uses. Some sprayers can control one or more of the following: a fluid flow rate; a fluid speed; a fluid exit direction from the nozzle, a flow shape as the fluid exits the nozzle (e.g., jetted, mist, fan, cone shaped, etc.), and a pressure of the fluid as it exits the nozzle. The sprayer is usually connected to a hose or pipe that is in turn connected to a source providing the fluid.

### SUMMARY

An aspect of the disclosure provides a sprayer that includes a nozzle, a nozzle actuator connected to the nozzle, and a controller in communication with the nozzle actuator. The controller receives wind data, determines a nozzle adjustment based on the wind data, and controls the nozzle actuator to alter a spray state of the nozzle based on the nozzle adjustment.

Implementations of the disclosure may include one or more of the following features. In some implementations, the wind data includes one or more of a wind speed and a wind direction. The wind data may include other wind or air characteristics as well, such as, but not limited to, humidity, temperature, and altitude.

In some implementations, the controller controls the nozzle actuator to alter the spray state of the nozzle by altering a spray pattern of the nozzle from a current nozzle spray pattern to an adjusted nozzle spray pattern. The nozzle may include a shaper and the nozzle actuator may include a shaper actuator arranged to move the shaper of the nozzle. Movement of the shaper alters the spray pattern of the nozzle. The nozzle actuator may define a forward spray direction and a vertical axis. In some examples, the nozzle actuator pans the nozzle about the vertical axis and tilts the nozzle with respect to the vertical axis.

In some implementations, the controller controls the nozzle actuator to alter the spray state of the nozzle by moving the nozzle from a current nozzle position to an adjusted nozzle position. Each nozzle position has a pan angle with respect to the forward spray direction and a tilt angle with respect to the vertical axis.

The nozzle actuator may include an articulated supply conduit that delivers fluid to the nozzle. The supply conduit articulates to pan and tilt the nozzle. In some examples, the nozzle actuator includes a panning actuator connected to a first articulable joint of the supply conduit and a tilt actuator connected to a second articulable joint of the supply conduit. The nozzle actuator may move one articulable joint at a time or both simultaneously.

The sprayer may include a flow rate sensor in communication with the controller. The flow rate sensor determines a flow rate of fluid flowing through the nozzle. The controller determines the nozzle adjustment based on the fluid flow rate.

In some implementations, the controller controls the nozzle actuator to alter the spray state of the nozzle by altering the flow rate of the nozzle from a current flow rate to an adjusted flow rate. The controller may make the nozzle adjustment or flow rate adjustment based on a current sensed flow rate (e.g., via the flow rate sensor) to maintain a flow of fluid on a target object. In some examples, the controller determines the nozzle adjustment by determining a wind vector based on the wind data and determining a current nozzle spray vector based on the current nozzle position, a current spray pattern, and the current flow rate. The controller also determines an adjustment vector by subtracting the wind vector from the current nozzle spray vector and determines the adjusted nozzle position, an adjusted spray pattern, and the adjusted flow rate of the nozzle to spray fluid according to the adjustment vector.

Another aspect of the disclosure provides a system for spraying fluid. The system includes a nozzle, a nozzle actuator connected to the nozzle a wind sensor, and a controller in communication with the nozzle actuator and the wind sensor. The controller receives wind data from the wind sensor, determines a nozzle adjustment based on the wind data, and controls the nozzle actuator to alter a spray state of the nozzle based on the nozzle adjustment.

In some implementations, the wind data includes one or more of a wind speed and a wind direction. The wind data may include other wind or air characteristics as well, such as, but not limited to, humidity, temperature, and altitude.

In some implementations, the controller controls the nozzle actuator to alter the spray state of the nozzle by altering a spray pattern of the nozzle from a current nozzle spray pattern to an adjusted nozzle spray pattern. The nozzle may include a shaper and the nozzle actuator may include a shaper actuator arranged to move the shaper of the nozzle. Movement of the shaper alters the spray pattern of the nozzle. The nozzle actuator may define a forward spray direction and a vertical axis. In some examples, the nozzle actuator pans the nozzle about the vertical axis and tilts the nozzle with respect to the vertical axis.

In some implementations, the controller controls the nozzle actuator to alter the spray state of the nozzle by moving the nozzle from a current nozzle position to an adjusted nozzle position. Each nozzle position has a pan angle with respect to the forward spray direction and a tilt angle with respect to the vertical axis.

The nozzle actuator may include an articulated supply conduit that delivers fluid to the nozzle. The supply conduit articulates to pan and tilt the nozzle. In some examples, the nozzle actuator includes a panning actuator connected to a first articulable joint of the supply conduit and a tilt actuator connected to a second articulable joint of the supply conduit. The nozzle actuator may move one articulable joint at a time or both simultaneously.

The system may include a flow rate sensor in communication with the controller. The flow rate sensor determines a flow rate of fluid flowing through the nozzle. The controller determines the nozzle adjustment based on the fluid flow rate.

In some implementations, the controller controls the nozzle actuator to alter the spray state of the nozzle by altering the flow rate of the nozzle from a current flow rate to an adjusted flow rate. The control may make the nozzle adjustment or flow rate adjustment based on a current sensed flow rate (e.g., via the flow rate sensor) to maintain a flow of fluid on a target object. In some examples, the controller determines the nozzle adjustment by determining a wind vector based on the wind data and determining a current nozzle spray vector based on the current nozzle position, a current spray pattern, and the current flow rate. The controller also determines an adjustment vector by subtracting the wind vector from the current nozzle spray vector and determines the adjusted nozzle position, an adjusted spray pattern, and the adjusted flow rate of the nozzle to spray fluid according to the adjustment vector.

Yet another aspect of the disclosure provides a method for spraying fluid. The method includes flowing fluid through a nozzle, receiving wind data from a wind sensor, determining a nozzle adjustment based on the wind data, and controlling a nozzle actuator connected to the nozzle to alter a spray state of the nozzle based on the nozzle adjustment.

In some implementations, receiving the wind data includes receiving one or more of a wind speed and a wind direction. The method may include controlling the nozzle actuator to alter a spray pattern of the nozzle from a current nozzle spray pattern to an adjusted nozzle spray pattern. In some examples, the method includes controlling the nozzle actuator to move a shaper of the nozzle. Movement of the shaper alters the spray pattern of the nozzle.

The nozzle actuator defines a forward spray direction and a vertical axis. Controlling the nozzle actuator may include panning the nozzle about the vertical axis and tilting the nozzle with respect to the vertical axis. The method may include controlling the nozzle actuator to move the nozzle from a current nozzle position to an adjusted nozzle position. Each nozzle position has a pan angle with respect to the forward spray direction and a tilt angle with respect to the vertical axis.

In some implementations, the method includes determining a flow rate of fluid flowing through the nozzle and determining the nozzle adjustment based on the fluid flow rate. The method may include controlling the nozzle actuator to alter the flow rate of the nozzle from a current flow rate to an adjusted flow rate. In some examples, the method includes determining the nozzle adjustment by determining a wind vector based on the wind data and determining a current nozzle spray vector based on the current nozzle position, a current spray pattern, and the current flow rate. The method may further include determining an adjustment vector by subtracting the wind vector from the current nozzle spray vector and determining the adjusted nozzle position, an adjusted spray pattern, and the adjusted flow rate of the nozzle to spray fluid according to the adjustment vector.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for spraying fluid.

FIG. 2A is a perspective view of an exemplary sprayer.

FIG. 2B is another perspective view of the sprayer shown in FIG. 2A.

FIG. 2C is yet another perspective view of the sprayer shown in FIG. 2A.

FIG. 2D is a perspective view of an exemplary overview of an adjustable pattern and adjustable flow nozzle.

FIG. 2E is an exploded view of the exemplary adjustable pattern and adjustable flow nozzle of FIG. 2D.

FIG. 2F is a side view of the exemplary adjustable pattern and adjustable flow nozzle of FIG. 2D.

FIG. 2G is a sectional view of the exemplary adjustable pattern and adjustable flow nozzle of FIG. 2F showing liquid flowing through the nozzle.

FIG. 3 is a schematic view of an example system for spraying fluid.

FIG. 4 is a schematic view of an exemplary sprayer;

FIG. 5A is a schematic view of an example arrangement of operations for spraying fluid.

FIG. 5B is a schematic view of an example arrangement of operations for determining a nozzle adjustment.

FIG. 6 is an example state diagram of a sprayer.

FIG. 7 is another example state diagram of a sprayer.

FIG. 8 is yet another example state diagram of a sprayer.

### DETAILED DESCRIPTION

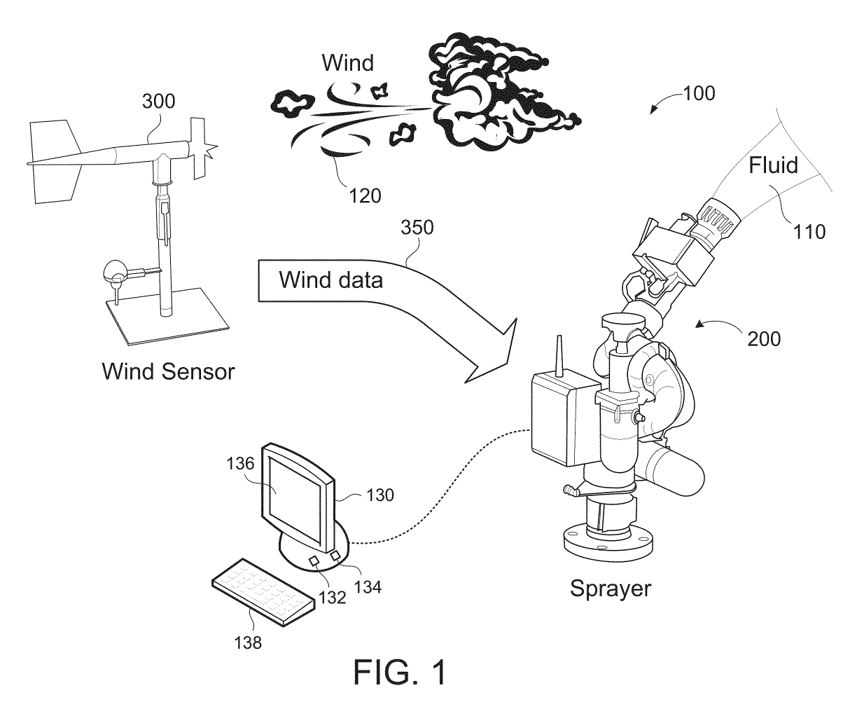

FIG. 1 illustrates a system 100 for spraying fluid 110. The system 100 includes a sprayer 200 and a wind sensor 300. The sprayer 200 receives wind data 350 from the wind sensor 300. Although the wind sensor 300 is shown as being separate from the sprayer 200, in some implementations, the wind sensor 300 is integrated into the sprayer 200. The system 100 may be used to spray fluid 110 on various objects, such as vehicles, trucks, or airplanes. In irrigation, the system 100 may be used to supply water, liquid fertilizer, herbicide or pesticide to agricultural crops. Similarly, in home gardens or on golf courses, the system 100 may be used to sprinkle water, plant food, liquid fertilizer, herbicide or pesticide to grass or plants. In fire-fighting, the system 100 may be used to discharge water, carbon dioxide or nitrogen to extinguish fires.

When the system 100 sprays fluid outdoors, wind 120 may alter an intended trajectory of the fluid 110. In some instances, the wind 120 may alter the trajectory of the fluid 110 to such a great extent that the fluid 110 may entirely miss an intended target of the system 100. In such scenarios, if the system 100 does not alter the trajectory of the fluid 110, as compensation for the wind 120, the system 100 may not spray all or some portion of the intended target and waste the fluid 110.

This disclosure presents a sprayer that includes a nozzle, a nozzle actuator connected to the nozzle and a controller in communication with the nozzle actuator. The controller receives wind data, determines a nozzle adjustment based on the wind data and controls the nozzle actuator to alter a spray state of the nozzle based on the nozzle adjustment. Advantageously, the sprayer can compensate for wind to mitigate fluid wastage and to ameliorate the spraying of the object.

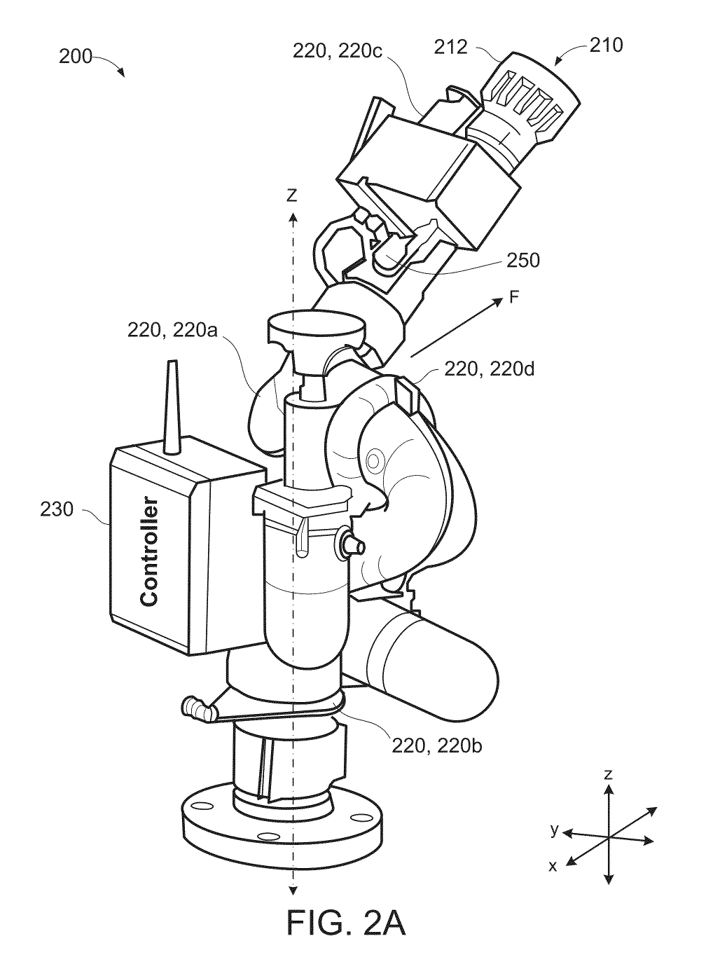

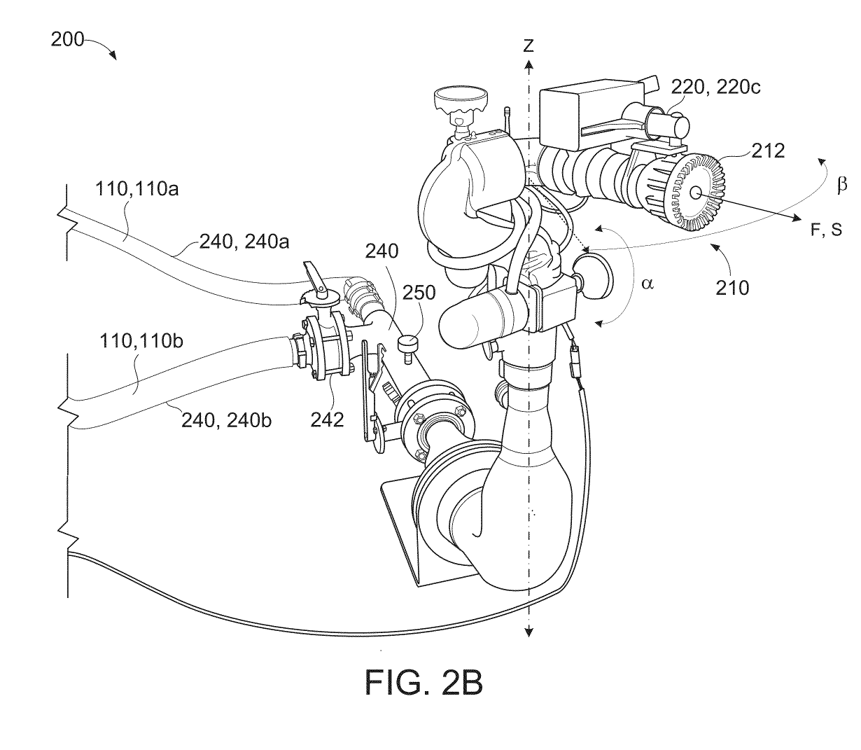

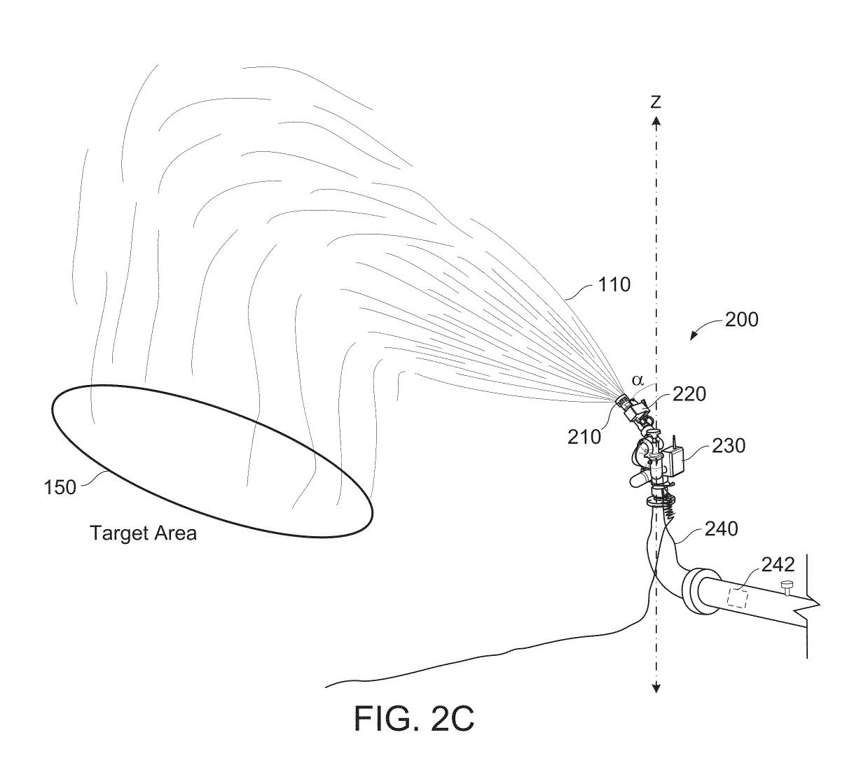

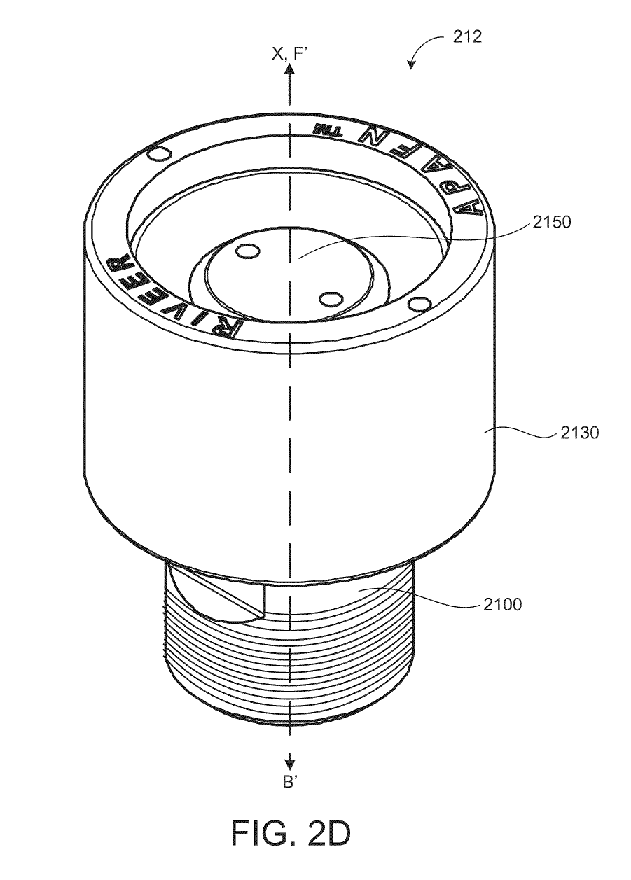

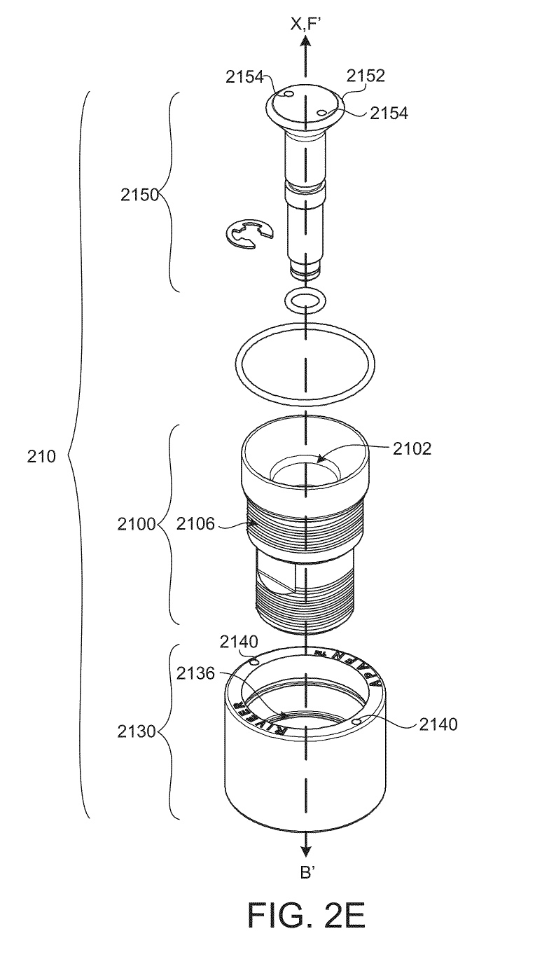

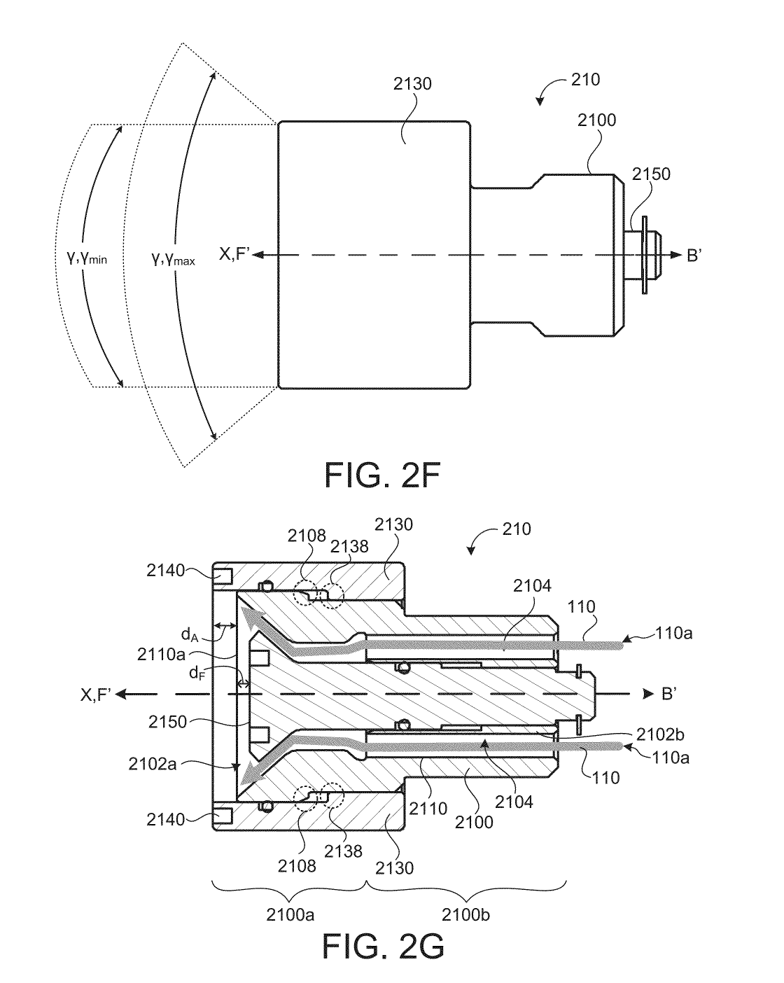

Referring to FIGS. 2A-2C, in some implementations, the sprayer 200 includes a nozzle 210 and a nozzle actuator 220 connected to the nozzle 210. The sprayer 200 also includes a controller 230 in communication with the nozzle actuator 220. The controller 230 controls the nozzle actuator 220 to alter a spray state of the nozzle 210.

The nozzle 210 includes several spray states. In some implementations, the spray states of the nozzle 210 vary based on the direction in which the nozzle 210 is spraying the fluid 110. In other implementations, the spray states of the nozzle 210 may vary based on the flow rate of the fluid 110 exiting the nozzle 210. In yet other implementations, the spray states of the nozzle 210 may vary based on the shape of the fluid 110 as the fluid 110 exits the nozzle 210. The nozzle 210 includes a shaper 212 that can change the shape of the fluid 110 as the fluid 110 exits the nozzle 210. The shaper 212 may create one or more flow patterns, such as a spraying pattern, a misting pattern, a fanning pattern, a jet pattern, a shower pattern, a cone pattern, a discharging pattern, or the like.

The nozzle actuator 220 may include a tilt actuator 220a, a panning actuator 220b, a shaper actuator 220c, and/or a flow rate actuator 220d. The tilt actuator 220a defines a forward spray direction F and a vertical axis Z. The tilt actuator 220a changes the spray state of the nozzle 210 by tilting the nozzle 210 with respect to the vertical axis Z. The tilt actuator 220a may tilt the nozzle within a tilt angle α, which may be centered on the forward spray direction F. The tilt angle α may be between about 30° and about 180° (e.g., between 45° and 70°). The panning actuator 220b changes the spray state of the nozzle 210 by panning the nozzle 210 about the vertical axis Z. The panning actuator 220b may pan the nozzle 210 within a panning angle β, which may be centered on the forward spray direction F. The panning angle β may be between about 30° and about 360° (e.g., between 45° and 180°).

In some implementations, the shaper actuator 220c changes the spray state of the nozzle 210 by moving the shaper 212, so that the fluid 110 exiting the nozzle 210 passes through a different shaper pattern. For example, the shaper actuator 220c can place the nozzle 210 in a misting spray state by moving the shaper 212 so that fluid 110 exiting the nozzle 210 passes through the misting pattern. Similarly, the shaper actuator 220c can place the nozzle 210 in a fanning spray state by moving the shaper 212 so that fluid 110 exiting the nozzle 210 passes through the fanning pattern. The shaper 212 may define a shaper axis S and the shaper actuator 220c may move the shaper 212 by rotating the shaper about the shaper axis S defined by the shaper 212.

Referring to FIG. 2D-2G, in some implementations, the nozzle 210 includes a stem 2100, a shaper collar 2130, and a plunger 2150. The stem 2100 has a first portion 2100a and a second portion 2100b and defines a center axis X through the first and second portions 2100a, 2100b. The stem 2100 defines a bore 2102 along the center axis X. In some examples, the bore 2102 includes a first bore 2102a and a second bore 2102b. The first bore 2102a is in fluid communication with the second bore 2102b and allows the plunger 2150 to be inserted into the first and second bores 2102a, 2102b. In some examples, at least one conduit 2104 is adjacent to the second bore 2102b and allows fluid 110 to flow from the conduit 2104 to the first bore 2102a.

In some examples, the second portion 2100b of the stem 2100 defines one or multiple liquid bores or conduits 2104 arranged around the second bore 2102b. Each conduit 2104 is in fluid communication with the first bore 2102a. The conduit 2104 allows the fluid 110 to flow from the supply conduit 240 removably attached to the stem 2100 to the target area 150. At least one conduit 2104 is in fluid communication with at least the first bore 2102a.

The shaper collar 2130 is movably received over the stem 2100 for movement along the center axis X. In some implementations, the stem 2100 defines a first threaded portion 2106 adjacent to first feature 2108 and the shaper collar 2130 defines a complimentary second threaded portion 2136 adjacent a second limit feature 2138. The shaper collar 2130 is threadably received on the first threaded portion 2106 of the stem 2100.

A flow distance d_{F} is a distance between a first surface 2110a of an inner surface 2110 of the stem 2100 and the plunger 2150. At a minimum flow distance d_{F} the head 2152 of the plunger 2150 is in contact with the first surface 2110a of the inner surface 2110 of the stem 2100 and prevents any fluid 110 from flowing through the fluid path 110a. At a maximum flow distance d_{F} the plunger 2150 is furthest from the first surface 2110a of the inner surface 2110 of the stem 2100 and allows for the greatest fluid path 110a. A user or the nozzle actuator 220 (e.g. the flow rate actuator 220d) may adjust the flow distance d_{F} to provide a fluid path 110a of fluid 110 between 1 and 35 gallons per minute and a pressure of between 10 psi and 1200 psi.

A user or the nozzle actuator 220 may adjust one or both of the angular distance d_{A} and flow distance d_{F}. A user or the nozzle actuator 220 may adjust the flow distance d_{F} by rotating the plunger 2150 about the center axis X (e.g., screwing the plunger 2150 with respect to the threadably received stem 2100). As the user or the nozzle actuator 220 (e.g. the shaper actuator 220c) rotates the plunger 2150 towards a forward direction F′, the flow distance d_{F} increases allowing an increase or widening of the fluid path 110a. Moreover, if the user or the shaper actuator 220c rotates the plunger 2150 in a backward direction B′ about the center axis X, the flow distance d_{F} decreases allowing a decrease in fluid path 110a, The shaper actuator 220c can alter the shape of the fluid 110 in the manner described above.

Additionally or alternatively, a user or the nozzle actuator 220 (e.g., the shaper actuator 220c) may adjust the angular distance d_{A} by rotating the shaper collar 2130 about the center axis X towards the forward direction F′ or the backward direction B′. In some examples, the shaper collar 2130 is threadably received over the stem 2100, and rotation of the shaper collar 2130 with respect to the stem 2100 causes the shaper collar 2130 to move axially along the center axis X with respect to the stem 2100. Movement of the shaper collar 2130 towards the forward direction F′ increases the angular distance d_{A} allowing a narrower flow angle γ leading to a jet pattern, for example. Movement of the shaper collar 2130 towards the backward direction B′ decreases the angular distance d_{A} allowing a wider flow angle γ leading to a shower pattern or a mist pattern, for example.

A user or the nozzle actuator 220 may rotate the shaper collar 2130 or the plunger 2150 with respect to the threadably received stem 2100. In some examples, the user or the nozzle actuator 220 needs tools to rotate either the shaper collar 2130 or the plunger 2150. In some examples, the shaper collar 2130 includes two receptacles 2140 for receiving a tool (not shown) having a complementary shape to adjust the shaper collar 2130, thus adjusting the flow angle γ. Additionally or alternatively, the plunger 2150 may include two plunger receptacles 2154 for receiving a tool having complementary shapes to adjust the plunger 2150 and control the flow rate. Therefore, a unique tool might be needed to make any adjustments to the nozzle 210, providing a tamper-proof setting, which is only adjustable by trained users having the right tools. In other examples, the nozzle 210 is adjustable with tool-less features.

The flow rate actuator 220d changes the spray state of the nozzle 210 by altering the rate of flow of the fluid 110 through the nozzle 210. The flow rate actuator 220d can change the spray state of the nozzle 210 by increasing or decreasing the rate of flow of fluid 110 through the nozzle 210. The flow rate actuator 220d may include a valve, for example, a solenoid valve.

The nozzle actuator 220 may include a hydraulic actuator that includes a cylinder or fluid motor that uses hydraulic power of the fluid to alter the spray state of the nozzle 210. The nozzle actuator 220 may include a pneumatic actuator that converts energy formed by compressed air at high pressure to alter the spray state of the nozzle 210. In some examples, the nozzle actuator 220 includes an electric motor. The tilt actuator 220a may use the electric motor to tilt the nozzle 210 with respect to the vertical axis Z defined by the tilt actuator 220a. Similarly, the panning actuator 220b may use the electric motor to pan the nozzle 210 about the vertical axis Z.

The controller 230 is in electronic communication with the nozzle actuator 220. The controller 230 receives wind data 350, determines a nozzle adjustment based on the wind data 350 and controls the nozzle actuator 220 to alter the spray state of the nozzle 210 based on the nozzle adjustment.

The controller 230 may include a programmable logic controller (PLC) that can be programmed in various different ways. For example, the PLC can be programmed from relay-derived ladder logic, state diagrams or state transition tables. This disclosure provides example state diagrams for programming the PLC.

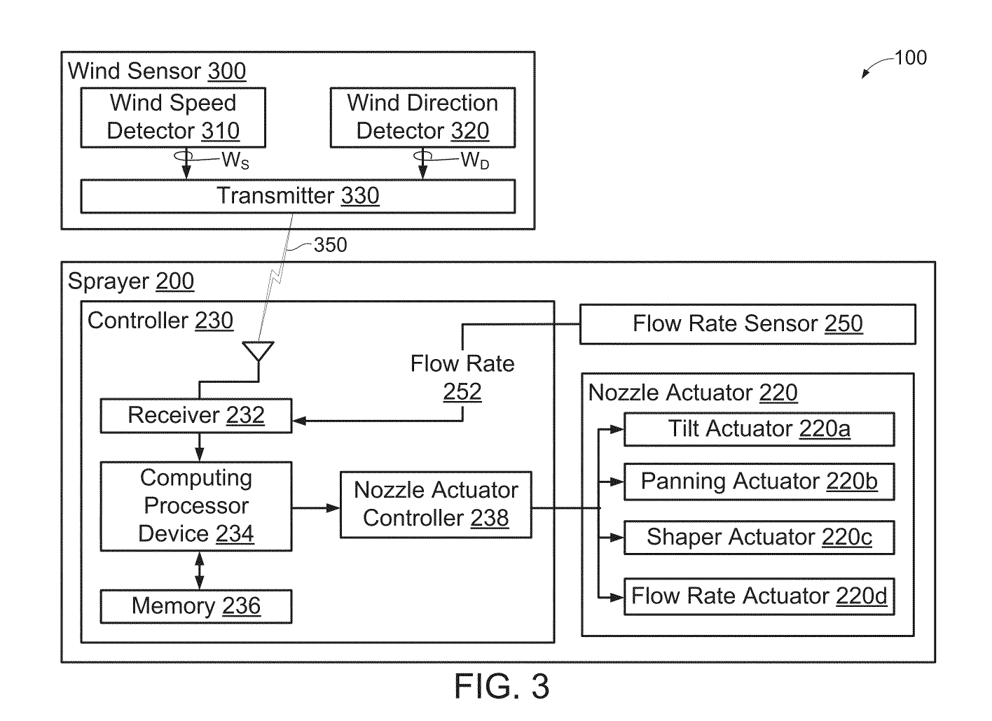

In some implementations, the controller 230 can be programmed by connecting the controller 230 to a computer 130 (FIG. 1) via Ethernet, RS-232, RS-485 or RS-422 cabling. The computer 130 includes a data processing device 132 (e.g., a computing device that executes instructions) and non-transitory memory 134 in communication with the data processing device 132. The computer 130 may also include a display 136 (e.g., touch display or non-touch display) and/or a keyboard 138 in communication with the data processing device 132. The computer 130 may transfer program logic to the controller 230 via a wired or wireless connection. In some implementations, the controller 230 includes a wireless transceiver 232 (FIG. 3) that wirelessly receives program logic from another device. The wireless transceiver 232 may include a Wireless Local Area Network (WLAN) transceiver, a Bluetooth transceiver, a ZigBee transceiver, a cellular transceiver, or the like. In some implementations, the controller 230 may include a processor or a microprocessor instead of or in addition to a PLC.

FIG. 2B illustrates a perspective view of the sprayer 200. The sprayer 200 includes an articulated supply conduit 240 that receives fluid 110 from a fluid source (not shown) that the sprayer 200 sprays through the nozzle 210. In the example shown, the articulated supply conduit 240 includes a first supply conduit 240a and a second supply conduit 240b. The first supply conduit 240a delivers a first fluid 110a to the sprayer 200 and the second supply conduit 240b delivers a second fluid 110b to the sprayer 200. For example, when the sprayer 200 is used to rinse airplanes, the first supply conduit 240a can import water and the second supply conduit 240b can import liquid soap. In another example, when the sprayer 200 is used in an agricultural field, the first supply conduit 240a can import water and the second supply conduit 240b can import fertilizer. In yet another example, when the sprayer 200 is used in firefighting, the first supply conduit 240a can import water and the second supply conduit 240b can import liquid foam.

The sprayer 200 includes a supply conduit valve 242. The supply conduit valve 242 controls the flow rate of the fluid through the supply conduit 240. Although, in the example shown, the supply conduit valve 242 is positioned to control the flow rate of the second supply conduit 240b, in other implementations, the supply conduit valve 242 may be positioned to control the flow rate of the first conduit 240a, the second conduit 240b, or both the first conduit 240a and the second conduit 240b. The controller 230 controls the position of the supply conduit valve 242 to adjust the flow rate of the fluid 110, 110a, 110b through the supply conduit 240.

FIG. 2C provides a perspective view of the sprayer 200 spraying fluid 110 through the nozzle 210. The sprayer 200 is spraying the fluid 110 onto a target area 150. The controller 230 directs the fluid 110 onto the target area 150 by controlling the spray state of the nozzle 210. For example, the controller 230 may adjust the tilt angle α and/or the panning angle β of the nozzle 210, so that the nozzle 210 sprays the fluid 110 in the same direction as the target area 150. The controller 230 may also adjust the flow rate of the fluid 110 by adjusting a position of the supply conduit valve 242, so that the fluid 110 reaches the target area 150. In the example shown, the supply conduit valve 242 is integrated into the supply conduit 240.

FIG. 3 is a block diagram of the example system 100 shown in FIG. 1, which includes the sprayer 200 and the wind sensor 300. The wind sensor 300 includes a wind speed detector 310, a wind direction detector 320 and a transmitter 330. The wind speed detector 310 detects a speed W_{S} of the wind 120. The wind direction detector 320 detects a direction W_{D} of the wind 120. The transmitter 330 transmits the detected wind speed W_{S} and the detected wind direction W_{D} to the sprayer 200. In some implementations, the wind speed detector 310 directly measures the wind speed W_{S}. In other implementations, the wind speed detector 310 measures wind pressure and uses the wind pressure to determine the wind speed W_{S}, for example, by retrieving a corresponding wind speed W_{S} from a lookup table for a given wind pressure measurement.

in some implementations, the wind speed detector 310 includes a velocity anemometer, such as a cup anemometer, a windmill anemometer, a hot-wire anemometer, a laser Doppler anemometer, a sonic anemometer, an acoustic resonance anemometer or a ping-pong ball anemometer. In other implementations, the wind speed detector 310 includes a pressure anemometer, such as a plate anemometer or a tube anemometer. The wind speed detector 310 may measure the wind speed W_{S} in knots (kn) or nautical miles per hour. Alternatively, the wind speed detector 310 may measure the wind speed W_{S} in miles per hour (mph), kilometers per hour (km/h), meters per second (m/s) or the like.

In some implementations, the wind direction detector 320 includes a weather vane. In other implementations, the wind direction detector 320 includes a windsock. Other instruments for detecting the direction of the wind are also possible. The wind direction detector 320 may measure the wind direction W_{D} in North azimuth degrees (0-360°). For example, a wind direction W_{D} of 45° corresponds with a Northeast wind. Alternatively, the wind direction detector 320 may reference the wind direction W_{D} to one of 16 points on a 16-point compass rose (e.g. North-northeast (NNE), East-northeast (ENE), etc.). Alternatively, the wind direction detector 320 may reference the wind direction W_{D} to one of 32 points on a 32-point compass rose (e.g. NtE that is half-way between NNE and N, EtN that is half-way between ENE and E, etc.).

The transmitter 330 transmits wind data 350 to the sprayer 200. In this implementation, the wind data 350 includes the wind speed W_{S} and the wind direction W_{D}. In other implementations, the wind data 350 may include only the wind speed W_{S} or only the wind direction W_{D}. In some implementations, the transmitter 330 transmits the wind data 350 wirelessly, for example, via Bluetooth, Wi-Fi, Zigbee, cellular radio, or the like. In other implementations, the transmitter 330 transmits the wind data 350 via a wired link, for example via Ethernet, USB (Universal Serial Bus), mini-USB, micro-USB, or the like.

In some implementations, the sprayer 200 includes a flow rate sensor 250 in communication with the controller 230. The flow rate sensor 250 measures a flow rate 252 of the fluid 110 through the sprayer 200. In some implementations, the flow rate sensor 250 includes a vane that is positioned inside the supply conduit 240. The vane is coupled with a wiper of a potentiometer. As fluid 110 passes through the supply conduit 240, the fluid 110 pushes the vane, which moves the wiper and changes the resistance of the potentiometer. In this example, the flow rate sensor 250 determines the flow rate 252 by retrieving a corresponding flow rate 252 from a lookup table for a given resistance value of the potentiometer. Other instruments for measuring the flow rate 252 of the fluid 110 are also possible. The flow rate sensor 250 sends the flow rate 252 to the controller 230.

The controller 230 includes a receiver 232, a computing processor device 234 (“processor 234”, hereinafter), a memory 236 (e.g., non-transitory memory, such as a hard disk, flash memory, random-access memory, etc.) and a nozzle actuator controller 238. The receiver 232 receives the wind data 350 from the wind sensor 300. In some implementations, the receiver 232 receives the wind data 350 wirelessly, for example, via Bluetooth, Wi-Fi, ZigBee, Near Field Communications (NFC), cellular radio or the like. In other implementations, the receiver 232 receives the wind data 350 via a wired link, for example, via Ethernet, USB or the like. The receiver 232 also receives the flow rate 252 from the flow rate sensor 250 (e.g., via uv/iced communication link or wireless communications).

The processor 234 stores the wind data 350 and the flow rate 252 in the memory 236. The processor 234 determines a nozzle adjustment based on the wind data 350, as described below. In some implementations, the processor 234 determines the nozzle adjustment further based on the flow rate 252. Advantageously, the sprayer 200 is able to take the wind 120 into account and ameliorate the spraying.

The nozzle actuator controller 238 controls the nozzle actuator 220 based on the nozzle adjustment. As discussed above, in some implementations, the nozzle actuator 220 includes an electric actuator such as an electric motor. The nozzle actuator controller 238 may generate pulse-width modulated (PWM) signals to control the electric motor in order to change the spray state of the sprayer 200 based on the nozzle adjustment.

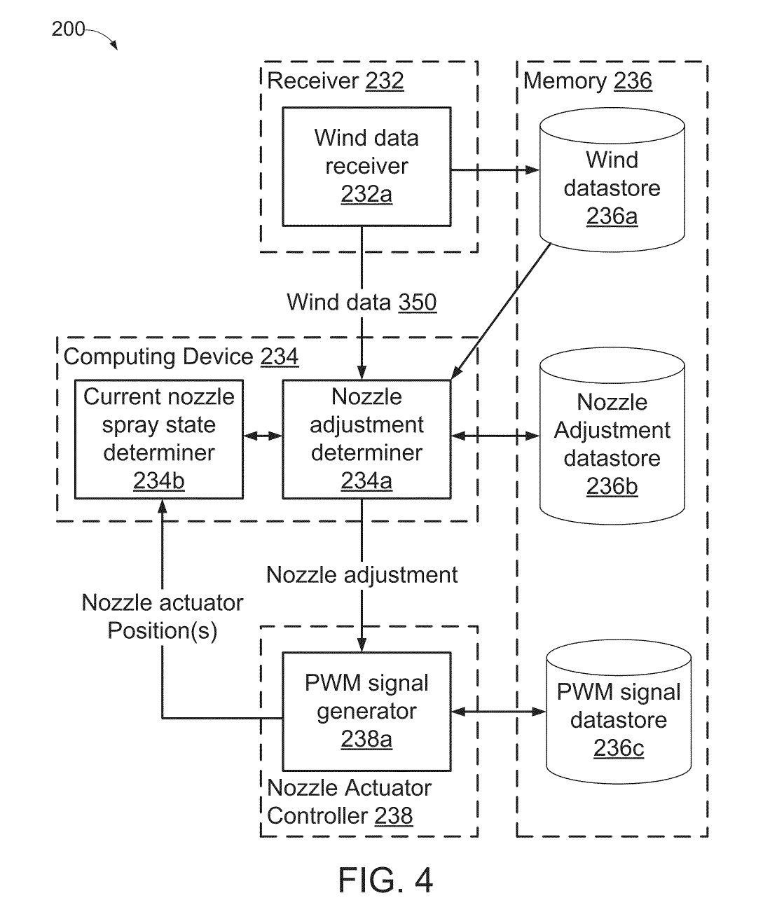

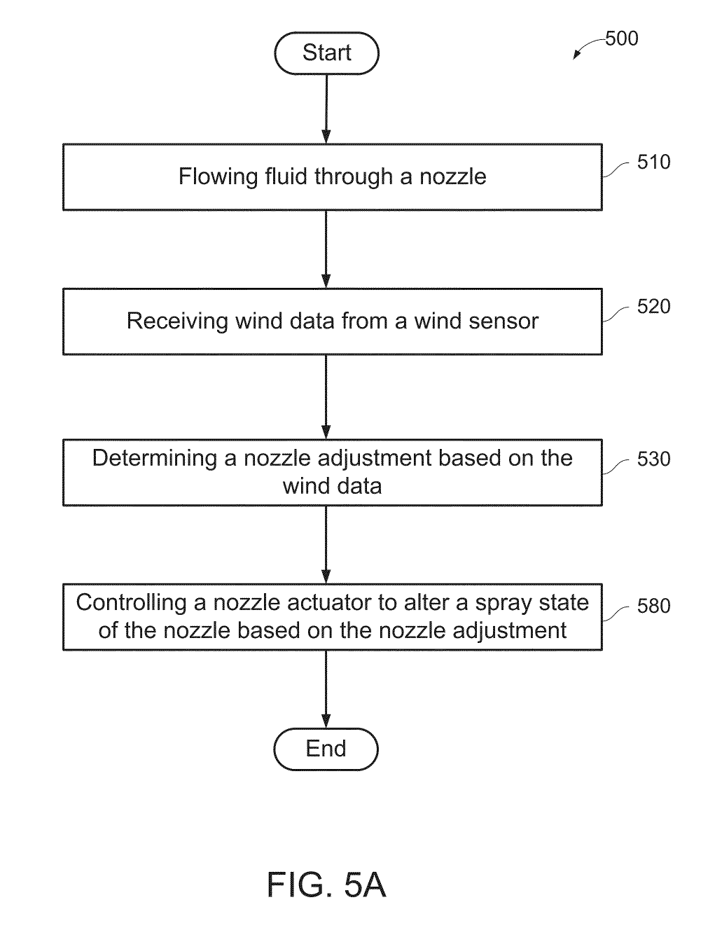

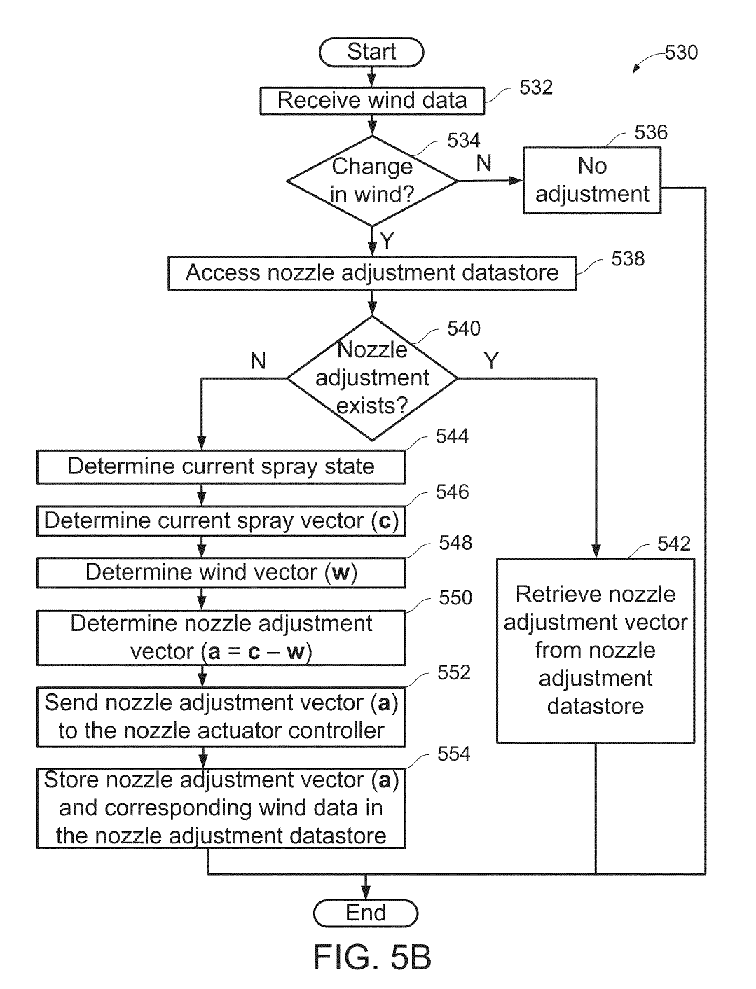

FIGS. 4, 5A, and 5B present an implementation of an example algorithm for spraying fluid and determining a nozzle adjustment. As shown in FIG. 4, the sprayer 200 includes a wind data receiver 232a, a nozzle adjustment determiner 234a, a current nozzle spray state determiner 234b, a wind datastore 236a, a nozzle adjustment datastore 236b, a PWM signal datastore 236c, and a PWM signal generator 238a.

The wind data receiver 232a receives wind data 350 via the receiver 232. As described above, the wind data 350 may include a wind speed W_{S} and/or a wind direction W_{D}. The wind data receiver 232a sends the wind data 350 to the nozzle adjustment determiner 234a. Additionally, or alternatively, the wind data receiver 232a may store the wind data 350 in the wind datastore 236a and the nozzle adjustment determiner 234a may retrieve the wind data 350 from the wind datastore 236a. The wind datastore 236a may be stored in the memory 236.

The nozzle adjustment determiner 234a receives the wind data 350 from the wind data receiver 232a and determines a nozzle adjustment based on the wind data 350. The nozzle adjustment determiner 234a queries the nozzle adjustment datastore 236b for a predetermined nozzle adjustment that corresponds with the wind data 350. The nozzle adjustment datastore 236b may store tilt angles a, panning angles β, shaper patterns and flow rates 252 for various wind data measurements. For example, the nozzle adjustment datastore 236b may store the following information:

TABLE 1
Example Nozzle adjustment datastore 236b

| | | | Adjusted Nozzle actuator positions | | | |
|---|---|---|---|---|---|---|
| | | | Tilt | Panning angle | | |
| | | | angle α | β from | | |
| | Wind data | | from | forward spray | Shaper | Flow |
| ID | Speed | Direction | vertical | direction (e.g. N) | pattern | rate |
| 1 | 5 mph | NW | 42° | 3° | Jet | 0.9 |
| 2 | 10 mph | NW | 38° | 5° | Jet | 0.85 |
| | . | . | . | . | . | . |
| | . | . | . | . | . | . |
| | . | . | . | . | . | . |

If the wind data 350 received by the nozzle adjustment determiner 234a matches any one of the wind data records in the nozzle adjustment datastore 236b, then the nozzle adjustment determiner 234a retrieves the corresponding nozzle adjustment from the nozzle adjustment datastore 236b. For example, if the wind data 350 includes a wind speed of 5 mph and a wind direction of NW, then the nozzle adjustment determiner 234a retrieves the first record (ID #1: 5 mph) from Table 1. In some scenarios, the nozzle adjustment determiner 234a may not find an exact match for the wind data 350 in the nozzle adjustment datastore 236b. In such scenarios, the nozzle adjustment determiner 234a may select a record that approximately matches the wind data 350. For example, if the wind data 350 includes a wind speed of 9 mph and a wind direction of NW, then the nozzle adjustment determiner 234a selects the second record (ID #2: 10 mph) from Table 1.

In some scenarios, selecting an approximate match may not be appropriate, for example when the wind data 350 is between two records. In such scenarios, the nozzle adjustment determiner 234a may use interpolation to determine the nozzle adjustment. For example, for a wind speed of 7.5 mph the nozzle adjustment determiner 234a may interpolate between the records for 5 mph and mph to determine the following nozzle adjustment:

TABLE 2
Using interpolation to determine nozzle adjustment

| | | | Adjusted Nozzle actuator positions | | | |
|---|---|---|---|---|---|---|
| | | | | Panning angle | | |
| | | | Tilt angle | from forward | | |
| | Wind data | | from | spray direction | Shaper | Flow |
| ID | Speed | Direction | vertical | (e.g. N) | pattern | rate |
| 1 | 5 mph | NW | 42° | 3° | Jet | 0.9 |
| | 7.5 mph | NW | 40° | 4° | Jet | 0.875 |
| 2 | 10 mph | NW | 38° | 5° | Jet | 0.85 |
| | . | . | . | . | . | . |
| | . | . | . | . | . | . |
| | . | . | . | . | . | . |

The nozzle adjustment determiner 234a may use extrapolation to determine the nozzle adjustment for wind data 350 that does not match any records in the nozzle adjustment datastore 236b and does not fall between any existing records. The nozzle adjustment determiner 234a may employ linear extrapolation by using the last two records in the nozzle adjustment datastore 236b. Alternatively, the nozzle adjustment determiner 234a may employ polynomial extrapolation by computing a polynomial equation using more than two records in the nozzle adjustment datastore 236b. For example, the nozzle adjustment determiner 234a may use 3, 5, 10 or all of the records in the nozzle adjustment datastore 236b to compute the polynomial equation. In this example, when the nozzle adjustment determiner 234a does not find a matching record for the wind data 350 in the nozzle adjustment datastore 236b, the nozzle adjustment determiner 234a analyzes the wind data 350 to determine a nozzle adjustment (as described below). The nozzle adjustment determiner 234a may analyze the wind data 350 instead of using interpolation or extrapolation.

The current nozzle spray state determiner 234b determines a current spray state of the nozzle 210. The current spray state includes information about the position of the nozzle actuator 220. The position of the nozzle actuator 220 may include a current tilt angle α, with respect to the vertical axis Z, a current panning angle β with respect to a forward spraying direction F (e.g. North), a current shaper pattern and a current flow rate 252. For example, the current spray state may be represented by:
(45°, 0°, Jet, 1) where:

45° represents the tilt angle α of the nozzle 210 with respect to a vertical axis Z,

0° represents the panning angle β of the nozzle 210 with respect to a forward spraying direction F (e.g. North),

Jet represents the shaper pattern, and

1 represents the flow rate 252 of fluid 110 flowing through the nozzle 210.

The nozzle adjustment determiner 234a receives the current spray state of the nozzle 210 from the current spray state determiner 234b. The nozzle adjustment determiner 234a computes a current spray vector (c) based on the current spray state. For the example spray state data provided above, the nozzle adjustment determiner 234a determines c to be (1, 45°, 0°). In this example, the nozzle adjustment determiner 234a is using spherical coordinates (r, Θ, Φ) where r is the flow rate, Θ is the tilt angle from the vertical axis and Φ is the panning angle from the forward spray direction (e.g. North). Although this example uses spherical coordinates, the nozzle adjustment determiner 234a may use cylindrical or Cartesian coordinates instead.

The nozzle adjustment determiner 234a determines a wind vector (w) based on the wind data 350. For example, the wind vector (w) for a wind speed of 5 mph and wind direction of NE may be represented by (5, 90°, 45°). The nozzle adjustment determiner 234a converts the wind speed W_{S} to the same unit as the flow rate 252 in the current spray vector (c). Alternatively, the nozzle adjustment determiner 234a normalizes the wind speed W_{S} and the flow rate 252, so that the magnitudes of the wind speed vector (w) and the current spray vector (c) are comparable and the nozzle adjustment determiner 234a can perform vector operations. In some examples, after the nozzle adjustment determiner 234a performs a unit conversion or normalization, the wind vector (w) may be represented by (0.3, 90°, 45°).

The nozzle adjustment determiner 234a determines a nozzle adjustment vector (a) based on the wind vector (w) and the current spray vector (c). In this example, the nozzle adjustment determiner 234a determines nozzle adjustment vector (a) by subtracting the wind vector (w) from the current spray vector (c):

a=c−w

The nozzle adjustment determiner 234a may perform the above vector subtraction in spherical coordinates, cylindrical coordinates or Cartesian coordinates. The nozzle adjustment determiner 234a may store the nozzle adjustment vector (a) along with the wind data 350 in the nozzle adjustment datastore 236b. Advantageously, the nozzle adjustment determiner 234a can retrieve the nozzle adjustment vector (a) for the wind data 350 from the nozzle adjustment datastore 236b whenever future wind data matches the wind data 350. The nozzle adjustment determiner 234a sends the nozzle adjustment vector (a) to the PWM signal generator 238a.

The PWM signal generator 238a receives the nozzle adjustment vector (a) from the nozzle adjustment determiner 234a. The PWM signal generator 238a generates PWM signals to move the nozzle actuator 220 to alter a spray state of the nozzle 210 from the current spray state to the adjusted spray state defined by the nozzle adjustment vector (a). In some examples, the PWM signal generator queries the PWM signal datastore 236c for a predetermined PWM signal that corresponds with the nozzle adjustment vector (a). The PWM signal datastore 236c may store information about the signal that can be applied to the nozzle actuator 220 to alter the spray state of the nozzle 210. For example, the PWM signal datastore 236c may store an amplitude and a period of a square wave that can be applied to the tilt actuator 220a to increase the tilt angle (Θ) by one degree. Similarly, the PWM signal datastore 236c may store an amplitude and a frequency of a sawtooth wave that can be applied to the panning actuator 220b to decrease the panning angle (Φ) by one degree. Other waveforms are possible as well The PWM signal generator 238a may use interpolation or extrapolation to determine a waveform when the PWM signal datastore 236c does not return an exact match for the nozzle adjustment vector (a).

FIG. 5A depicts an example method 500 for spraying fluid 110. When fluid 110 is flowing through a nozzle (at 510), wind 120 may alter the trajectory of the fluid 110. The method includes receiving wind data 350 from a wind sensor 300 (at 520) and determining a nozzle adjustment based on the wind data 350 (at 530). The method includes controlling a nozzle actuator 220 to alter a spray state of the nozzle 210 based on the nozzle adjustment (at 580). Advantageously, the altered spray state of the nozzle 210 mitigates the effect of the wind 120 and ameliorates the spraying.

FIG. 5B provides an exemplary arrangement of operations for a method 530 that includes determining a nozzle adjustment for the nozzle 210 based on wind data 350. The nozzle adjustment determiner 234a receives the wind data 350 (at 532). As described above, the wind data 350 may include a wind speed and a wind direction. The nozzle adjustment determiner 234a determines whether there has been a change in the wind (at 534) The nozzle adjustment determiner 234a queries the wind datastore 236a, retrieves a previous wind data measurement and compares the wind data 350 with the previous wind data measurement. If the wind data 350 matches the previous wind data measurement, then no nozzle adjustment is made (at 536) and the method 530 ends. If the wind data 350 is different from the previous wind data measurement, then the nozzle adjustment determiner 234a proceeds to determine a nozzle adjustment based on the wind data 350.

The nozzle adjustment determiner 234a accesses the nozzle adjustment datastore 236b (at 538). The nozzle adjustment determiner 234a queries the nozzle adjustment datastore 236b to determine whether a nozzle adjustment exists for the wind data 350 (at 540). The nozzle adjustment determiner 234a may query the nozzle adjustment datastore 236b using a SQL (Structured Query Language) query, for example:

SELECT * FROM NozzleAdjustmentDatastore
WHERE (WindSpeed=MeasuredSpeed) AND
(WindDirection=MeasuredDirection)

To increase the likelihood of receiving a result, the nozzle adjustment determiner 234a may expand the scope of the query by querying for approximate matches and not just exact matches. For example, the nozzle adjustment determiner 234a may retrieve records that are within a 10% threshold range of the measured wind data 350, An example query for retrieving approximate matches may resemble the following:

SELECT * FROM NozzleAdjustmentDatastore
WHERE WindSpeed BETWEEN (0.9*MeasuredSpeed) AND
(1.1*MeasuredSpeed)

If the query returns a result, then the nozzle adjustment determiner 234a retrieves the nozzle adjustment from the nozzle adjustment datastore 236b (at 542). In this example implementation, the nozzle adjustment determiner 234a retrieves a nozzle adjustment vector (a) from the nozzle adjustment datastore 236b and the method 530 ends, 11 the query does not return any results, then the nozzle adjustment determiner 234a proceeds to analyze the wind data 350 and determine a nozzle adjustment.

The nozzle adjustment determiner 234a sends a request to the current nozzle spray state determiner 234b to determine a current spray state of the nozzle 210 (at 544). The current nozzle spray state determiner 234b determines a position of the nozzle actuator 220. In this example, the current nozzle spray state determiner 234b determines a position of each nozzle actuator 220a, 220b, 220c and 220d. The current spray state determiner 234b receives the position of the nozzle actuator 220 from the nozzle actuator controller 238. The current nozzle spray state determiner 234b sends the current spray state of the nozzle 210 to the nozzle adjustment determiner 234a.

The nozzle adjustment determiner 234a determines a current spray vector (c) based on the current spray state of the nozzle 210 (at 546). As described above, the current spray vector (c) may be represented in spherical coordinates, cylindrical coordinates or Cartesian coordinates. The nozzle adjustment determiner 234a determines a wind vector (w) based on the wind data 350 (at 548). The wind vector (w) is represented in the same coordinate system as the current spray vector, so that nozzle adjustment determiner 234a can perform vector operations. As described above, the magnitudes of the current spray vector (c) and the wind vector (w) are normalized, so that the magnitudes are comparable and the nozzle adjustment determiner 234a can perform vector operations.

The nozzle adjustment determiner 234a determines a nozzle adjustment vector (a) based on the current spray vector (c) and the wind vector (w) (at 550). In some examples, the nozzle adjustment determiner 234a determines the nozzle adjustment vector (a) by subtracting the wind vector (w) from the current spray vector (c):

a=c−w

As described above, the nozzle adjustment determiner 234a may represent the nozzle adjustment vector (a) using spherical coordinates (r, α, β) where r is the flow rate, α is the tilt angle from the vertical axis and β is the panning angle from the forward spray direction (e.g. North). Alternatively, the nozzle adjustment vector (a) may be represented in cylindrical or Cartesian coordinates.

The nozzle adjustment determiner 234a sends the nozzle adjustment vector (a) to the nozzle actuator controller 238 (at 552). In some examples, the nozzle adjustment determiner 234a sends the nozzle adjustment vector (a) to the PWM signal generator 238a. As described above, the PWM signal generator 238a generates PWM signals to alter the spray state of the nozzle 210 in accordance with the nozzle adjustment vector (a). The nozzle adjustment determiner 234a stores the nozzle adjustment vector (a) in the nozzle adjustment datastore 236b (at 554) and the method 530 ends. Advantageously, by storing the nozzle adjustment vector (a) in the nozzle adjustment datastore 236b, the nozzle adjustment determiner 234a can retrieve the nozzle adjustment vector (a) from the nozzle adjustment datastore 236b for subsequent wind data measurements that match the wind data 350.

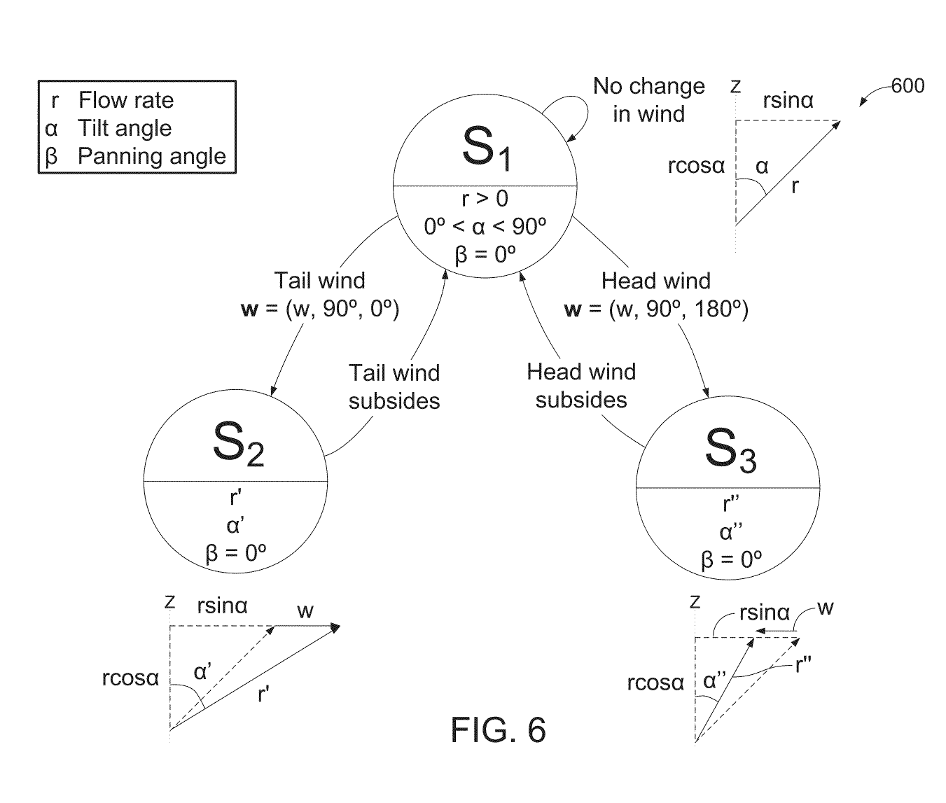

FIGS. 6-8 provide exemplary state diagrams for the sprayer 200. FIG. 6 illustrates an example spray state diagram 600 that includes three spray states: S1, S2 and S3. In the S1 spray state, the nozzle 210 is spraying fluid at a flow rate r, the tilt angle α is between 0° and 90° and the panning angle β is 0°. A panning angle β of 0° indicates that the nozzle 2110 is pointing towards the forward spray direction F (e.g. North). The nozzle 210 transitions from the S1 spray state to the S2 spray state in response to a tail wind 120. In the S2 spray state, the adjusted flow rate r′ and the adjusted tilt angle α′ are computed using the following equations:

$$\begin{matrix}{r}^{′} = \sqrt{{( r cos α )}^{2} + {( r sin α + w )}^{2}} & ( 1 ) \\ {α}^{′} = {tan}^{- 1} [ \frac{r sin α + w}{r cos α} ] & ( 2 )\end{matrix}$$

Similarly, the nozzle 210 transitions from the S1 spray state to the S3 spray state in response to a head wind. In the S3 spray state, the adjusted flow rate r″ and the adjusted tilt angle α″ are computed using the following equations:

$$\begin{matrix}{r}^{″} = \sqrt{{( r cos α )}^{2} + {( r sin α - w )}^{2}} & ( 3 ) \\ {α}^{″} = {tan}^{- 1} [ \frac{r sin α - w}{r cos α} ] & ( 4 )\end{matrix}$$

In this example state diagram 600, the head wind and the tail wind do not have any easterly or westerly components. Therefore, the panning angle β is not adjusted. In other states, the head wind and the tail wind may have easterly or westerly components and the panning angle β may need to be adjusted as well.

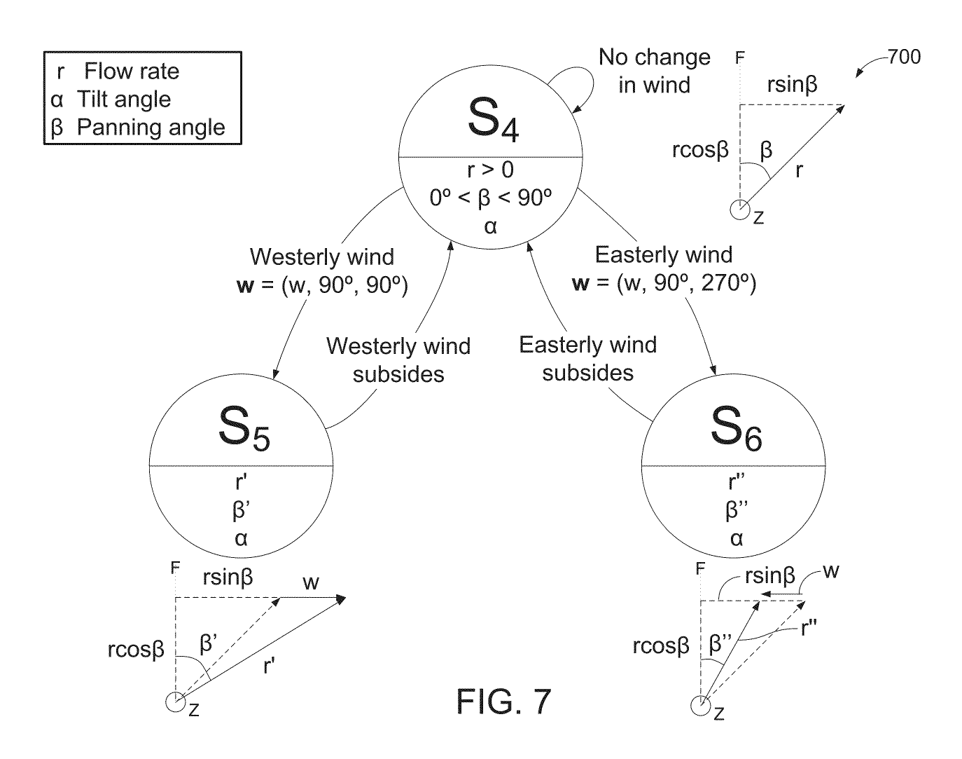

FIG. 7 illustrates an example spray state diagram 700 that includes three spray states: S4, S5 and S6. In the S4 spray state, the nozzle 210 is spraying fluid at a flow rate r and at a panning angle β. The sprayer 200 transitions from the S4 spray state to the S5 spray state in response to a westerly wind. A westerly wind is a wind that blows from the West and towards the East. In this example, the forward spray direction F of the sprayer 200 is North. To mitigate the effects of the westerly wind the sprayer 200 transitions from the S4 spray state to the S5 spray state. In the S5 spray state, the adjusted flow rate r′ and the adjusted panning β′ angle can be computed using the following equations:

$$\begin{matrix}{r}^{′} = \sqrt{{( r cos β )}^{2} + {( r sin β + w )}^{2}} & ( 5 ) \\ {β}^{′} = {tan}^{- 1} [ \frac{r sin β + w}{r cos β} ] & ( 6 )\end{matrix}$$

Similarly, the nozzle 210 transitions from the S4 spray state to the S6 spray state in response to an easterly wind. An easterly wind is a wind that blows from the East and towards the West. In the S6 spray state, the adjusted flow rate r″ and the adjusted panning angle β″ can be computed using the following equations:

$$\begin{matrix}{r}^{″} = \sqrt{{( r cos β )}^{2} + {( r sin β - w )}^{2}} & ( 7 ) \\ {β}^{″} = {tan}^{- 1} [ \frac{r sin β - w}{r cos β} ] & ( 8 )\end{matrix}$$

In this example state diagram 700, the westerly wind and the easterly wind do not have any north or south components. Therefore, the tilt angle α is not adjusted. In other states, the westerly wind and the easterly wind may have North or South components and the tilt angle α may need to be adjusted as well.

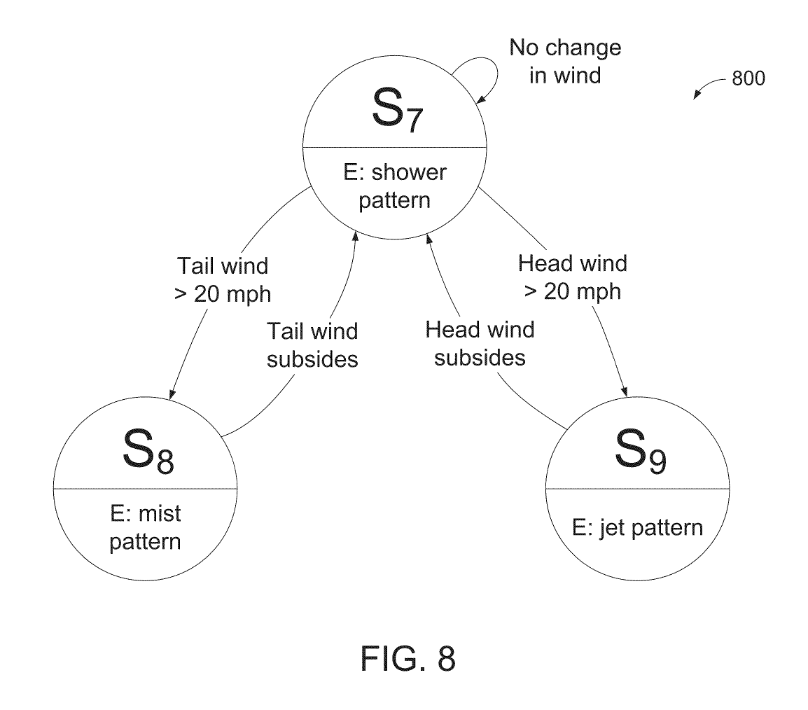

FIG. 8 illustrates an example spray state diagram 800 that includes three spray states: S7, S8 and S9. In the S7 spray state, the shaper 212 is using the shower pattern. In the presence of a strong tail wind, for example greater than 20 mph, the shaper 212 switches from the shower pattern to the mist pattern, as shown in the transition from spray state S7 to spray state S8. Since the strong tail wind helps carry the fluid forward, the shaper 212 is switched to a pattern in which the fluid has a greater surface area. This can help reduce the impact of the fluid on the object being sprayed and thereby prevent the object from being damaged due to excessive force. For example, if the sprayer 200 is being used to spray an airplane, excessive force may damage certain components of the airplane. Advantageously, by switching the shaper pattern to the mist pattern damage to the airplane may be prevented.

Similarly, in the presence of a strong head wind, the sprayer 200 transitions from the S7 spray state to the S9 spray state. In the S9 spray state, the shaper 212 uses the jet pattern. The jet pattern allows the fluid to cut through the strong head wind and still make contact with the Object being sprayed. In the presence of a strong head wind (e.g., greater than 20 mph), a shower pattern may not provide enough fluid pressure for the fluid to make contact with the object, whereas the jet pattern is more likely to allow the fluid to reach the object being sprayed.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment, A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASK:: (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a (processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e,g., HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A sprayer comprising:
a nozzle;
a nozzle actuator connected to the nozzle; and
a controller in communication with the nozzle actuator, the controller:
receiving wind data;
determining a nozzle adjustment based on the wind data; and
controlling the nozzle actuator to alter a spray state of the nozzle based on the nozzle adjustment.

2. The sprayer of claim 1, wherein the wind data comprises one or more of a wind speed and a wind direction.

3. The sprayer of claim wherein the controller controls the nozzle actuator to alter the spray state of the nozzle by altering a spray pattern of the nozzle from a current nozzle spray pattern to an adjusted nozzle spray pattern.

4. The sprayer of claim 3, wherein the nozzle comprises a shaper and the nozzle actuator comprises a shaper actuator arranged to move the shaper of the nozzle, movement of the shaper altering the spray pattern of the nozzle.

5. The sprayer of claim 1, wherein the nozzle actuator defines a forward spray direction and a vertical axis, the nozzle actuator panning the nozzle about the vertical axis and tilting the nozzle with respect to the vertical axis.

6. The sprayer of claim 5, wherein the controller controls the nozzle actuator to alter the spray state of the nozzle by moving the nozzle from a current nozzle position to an adjusted nozzle position, each nozzle position having a pan angle with respect to the forward spray direction and a tilt angle with respect to the vertical axis.

7. The sprayer of claim 5, wherein the nozzle actuator comprises an articulated supply conduit delivering fluid to the nozzle, the supply conduit articulating to pan and tilt the nozzle.

8. The sprayer of claim 7, wherein the nozzle actuator comprises:
a panning actuator connected to a first articulable joint of the supply conduit; and
a tilt actuator connected to a second articulable joint of the supply conduit.

9. The sprayer of claim 5, further comprising a flow rate sensor in communication with the controller, the flow rate sensor determining a flow rate of fluid flowing through the nozzle, the controller determining the nozzle adjustment based on the fluid flow rate.

10. The sprayer of claim 9, wherein the controller controls the nozzle actuator to alter the spray state of the nozzle by altering the flow rate of the nozzle from a current flow rate to an adjusted flow rate.

11. The sprayer of claim 10, wherein the controller determines the nozzle adjustment by:
determining a wind vector based on the wind data;
determining a current nozzle spray vector based on the current nozzle position, a current spray pattern, and the current flow rate;
determining an adjustment vector by subtracting the wind vector from the current nozzle spray vector; and
determining the adjusted nozzle position, an adjusted spray pattern, and the adjusted flow rate of the nozzle to spray fluid according to the adjustment vector.

12. A system for spraying fluid, the system comprising:
a nozzle;
a nozzle actuator connected to the nozzle;
a wind sensor; and
a controller in communication with the nozzle actuator and the wind sensor, the controller:
receiving wind data from the wind sensor;
determining a nozzle adjustment based on the wind data; and
controlling the nozzle actuator to alter a spray state of the nozzle based on the nozzle adjustment.

13. The system of claim 12, wherein the wind data comprises one or more of a wind speed and a wind direction.

14. The system of claim 12, wherein the controller controls the nozzle actuator to alter the spray state of the nozzle by altering a spray pattern of the nozzle from a current nozzle spray pattern to an adjusted nozzle spray pattern.

15. The system of claim 14, wherein the nozzle comprises a shaper and the nozzle actuator comprises a shaper actuator arranged to move the shaper of the nozzle, movement of the shaper altering the spray pattern of the nozzle.

16. The system of claim 12, wherein the nozzle actuator defines a forward spray direction and a vertical axis, the nozzle actuator panning the nozzle about the vertical axis and tilting the nozzle with respect to the vertical axis.

17. The system of claim 16, wherein the controller controls the nozzle actuator to alter the spray state of the nozzle by moving the nozzle from a current nozzle position to an adjusted nozzle position, each nozzle position having a pan angle with respect to the forward spray direction and a tilt angle with respect to the vertical axis.

18. The system of claim 16, wherein the nozzle actuator comprises an articulated supply conduit delivering fluid to the nozzle, the supply conduit articulating to pan and tilt the nozzle.

19. The system of claim 18, wherein the nozzle actuator comprises:
a panning actuator connected to a first articulable joint of the supply conduit; and
a tilt actuator connected to a second articulable joint of the supply conduit.

20. The system of claim 12, further comprising a flow rate sensor in communication with the controller, the fluid flow rate sensor determining a flow rate of fluid flowing through the nozzle, the controller determining the nozzle adjustment based on the fluid flow rate.

21. The system of claim 20, wherein the controller controls the nozzle actuator to alter the spray state of the nozzle by altering the flow rate of the nozzle from a current flow rate to an adjusted flow rate.

22. The system of claim 21, wherein the controller determines the nozzle adjustment by:
determining a wind vector based on the wind data;
determining a current nozzle spray vector based on the current nozzle position, a current spray pattern, and the current flow rate;
determining an adjustment vector by subtracting the wind vector from the current nozzle spray vector; and
determining the adjusted nozzle position, an adjusted spray pattern, and the adjusted flow rate of the nozzle to spray fluid according to the adjustment vector,

23. A method for spraying fluid, the method comprising:
flowing fluid through a nozzle;
receiving wind data from a wind sensor;
determining a nozzle adjustment based on the wind data; and
controlling a nozzle actuator connected to the nozzle to alter a spray state of the nozzle based on the nozzle adjustment.

24. The method of claim 23, wherein receiving the wind data comprises receiving one or more of a wind speed and a wind direction,

25. The method of claim 23, further comprising controlling the nozzle actuator to alter a spray pattern of the nozzle from a current nozzle spray pattern to an adjusted nozzle spray pattern.

26. The method of claim 25, further comprising controlling the nozzle actuator to move a shaper of the nozzle, movement of the shaper altering the spray pattern of the nozzle.

27. The method of claim 23, wherein the nozzle actuator defines a forward spray direction and a vertical axis; and wherein controlling the nozzle actuator comprises panning the nozzle about the vertical axis and tilting the nozzle with respect to the vertical axis.

28. The method of claim 27, further comprising controlling the nozzle actuator to move the nozzle from a current nozzle position to an adjusted nozzle position, each nozzle position having a pan angle with respect to the forward spray direction and a tilt angle with respect to the vertical axis.

29. The method of claim 18, further comprising:
determining a flow rate of fluid flowing through the nozzle; and
determining the nozzle adjustment based on the fluid flow rate.

30. The method of claim 29, further comprising controlling the nozzle actuator to alter the flow rate of the nozzle from a current flow rate to an adjusted flow rate.

31. The method of claim 30, further comprising determining the nozzle adjustment by:
determining a wind vector based on the wind data;
determining a current nozzle spray vector based on the current nozzle position, a current spray pattern, and the current flow rate;
determining an adjustment vector by subtracting the wind vector from the current nozzle spray vector; and
determining the adjusted nozzle position, an adjusted spray pattern, and the adjusted flow rate of the nozzle to spray fluid according to the adjustment vector.
